(19) United States
(12) Patent Application Publication
(10) Pub. No.: US 2015/0217414 A1
(43) Pub. Date: Aug. 6, 2015

(54) METHOD OF REMANUFACTURING A COMPONENT

(71) Applicant: Caterpillar Inc., Peoria, IL (US)

(72) Inventors: Kegan Luick, Corinth, MS (US); Benjamin C. Thomas, Peoria, IL (US); Curtis J. Graham, Peoria, IL (US); Adam Ostein, Edelstein, IL (US); Jarrod D. Moss, Corinth, MS (US); Patrick W. Savage, Jr., Washington, IL (US); Waylon Walker, Minier, IL (US); Kristin A. Schipull, Moorhead, MN (US); Robert E. Sharp, Corinth, MS (US)

(73) Assignee: Caterpillar Inc., Peoria, IL (US)

(21) Appl. No.: 14/172,054

(22) Filed: Feb. 4, 2014

(51) Int. Cl. B23P 6/00; B23K 26/34; B23K 26/30; B23K 26/16

(52) U.S. Cl. CPC B23P 6/00; B23K 26/16; B23K 26/345; B23K 26/421

(57) ABSTRACT

A method of remanufacturing a component having a heat treated hardened layer over a substrate material is disclosed. The method includes removing at least the heat treated hardened layer of the component to expose the substrate material. The method also includes providing a cladding material on the substrate material. The method further includes melting the cladding material via a laser beam to form a single layered coating with hardness greater than or substantially equal to hardness of the heat treated hardened layer, on the substrate material.

### TECHNICAL FIELD

The present disclosure relates to a method of remanufacturing a component, and more particularly to the method of remanufacturing the component having a heat treated hardened layer over a substrate material.

### BACKGROUND

Many components of an engine are required to perform in severe service applications due to designed stresses or environments. The components may include crankshafts, camshafts, pistons, gears, injector parts, etc. It is typical that heat treatment operations be used to create a metallurgical heat treated hardened layer of a required thickness over a substrate material, to improve the strength and wear properties of the substrate material. When components are installed into the intended application, during normal operation, different conditions and factors cause damage to the heat treated hardened layer. Accordingly, wear marks, scratches, scuffs, pitting, or other defects such as warping may be formed on the heat treated hardened layer.

It is undesirable to reuse the components whose heat treated hardened depth layer is damaged. Known solutions for remanufacturing of the heat treated hardened layer include an initial machining operation to remove the damage, followed by multiple layers of metal applied to the damaged area using welding or laser cladding techniques. However, this approach may not provide the same material quality as the original heat treatment process due to a tempering effect of the weld/clad on the surrounding material.

U.S. Pat. No. 7,827,883 discloses a cutting die formed by scanning a laser beam along a path corresponding to a blade pattern, and introducing a selected powder to build up an integral blade of high grade, and hard-to-wear material on the relatively softer die body. The final blade shape is machined or produced by EDM or milling. Further hardening by heat treatment is optional. Other heat sources and cladding materials could be used.

### SUMMARY OF THE DISCLOSURE

In one aspect of the present disclosure, a method of remanufacturing a component having a heat treated hardened layer over a substrate material is disclosed. The method includes removing at least the heat treated hardened layer of the component to expose the substrate material. The method also includes providing a cladding material on the substrate material. The method further includes melting the cladding material via a laser beam to form a single layered coating with hardness greater than or substantially equal to hardness of the heat treated hardened layer, on the substrate material. The single layered coating is machined to a desired thickness thereafter.

In another aspect of the present disclosure, a method of remanufacturing a component having a heat treated hardened layer over a substrate material is disclosed. The method includes removing the heat treated hardened layer and a thickness of the substrate material exposing a surface underneath. The method also includes providing a cladding material on the surface. The method further includes melting the cladding material via a laser beam to form a single layered coating with hardness greater than or substantially equal to hardness of the heat treated hardened layer, on the surface. The single layered coating has a thickness greater than a thickness of the heat treated hardened layer. The single layered coating is machined to a desired thickness thereafter.

In yet another aspect of the present disclosure, a remanufactured component having a substrate material is disclosed. The remanufactured component is prepared by a process which includes a step of removing at least a heat treated hardened layer of an original component to expose the substrate material. The process also includes a step of providing a cladding material on the substrate material. The process further includes melting the cladding material via a laser beam in a single pass to form a single layered coating with hardness greater than or substantially equal to hardness of the heat treated hardened layer, on the substrate material. The single layered coating has a thickness greater than a thickness of the removed heat treated hardened layer. Further, the single layered coating is machined to a desired thickness in order to provide the remanufactured component.

Other features and aspects of this disclosure will be apparent from the following description and the accompanying drawings.

### BRIEF DESCRIPTION OF THE DRAWINGS

FIG. 1 is a perspective view of an exemplary component;

FIG. 2 is a side view of the component of FIG. 1 at a processing stage, according to one embodiment of the present disclosure;

FIG. 3 is a side view of the component at yet another processing stage, according to another embodiment of the present disclosure;

FIG. 4 is a detailed perspective view of a bearing surface of the component at the processing stage of FIG. 3;

FIG. 5 is a perspective view of the remanufactured bearing surface, according to an embodiment of the present disclosure; and

FIG. 6 is a method of remanufacturing the component, according to an embodiment of the present disclosure.

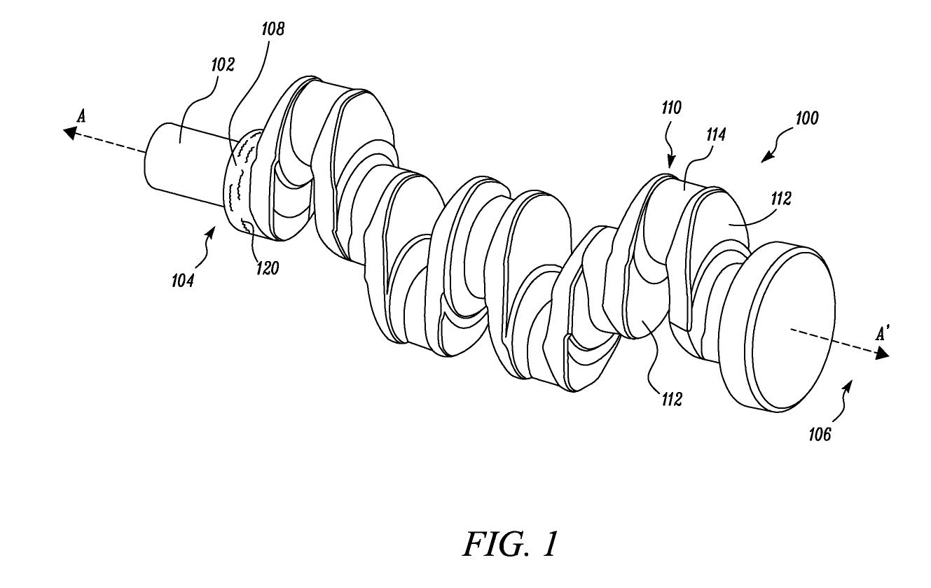

### DETAILED DESCRIPTION

Wherever possible, the same reference numbers will be used throughout the drawings to refer to the same or the like parts. FIG. 1 is a perspective view of an exemplary component 100. In the illustrated embodiment, the component 100 is a crankshaft of an engine. Alternatively, the component 100 may embody a camshaft, or any other high performance components used in a machine, such as gears, transmission shafts, bearings, valves and the like.

The component 100 may be rotatably mounted on bearings (not shown) within the engine. The component 100 shown in FIG. 1 includes an elongate shaft body 102. The shaft body 102 defines a longitudinal axis A-A′ extending between a first axial end 104 and a second axial end 106. A bearing surface 108 is positioned axially inward of the first axial end 104. The bearing surface 108 is configured to contact the bearings. The component 100 may include similar bearing surfaces (not numbered) axially spaced apart along the longitudinal axis A-A′. The bearing surface 108 may be substantially cylindrical and extend circumferentially about the axis A-A′.

Further, the component 100 also includes a crank or a crank throw 110. The component 100 of the present embodiment includes four crank throws 110. Each of the crank throw 110 includes a pair of webs 112 and a crank pin 114. The crank pins 114 are configured to receive an end of a connecting rod (not shown) through bearing journals, whereas another end of the connecting rod is attached to the piston.

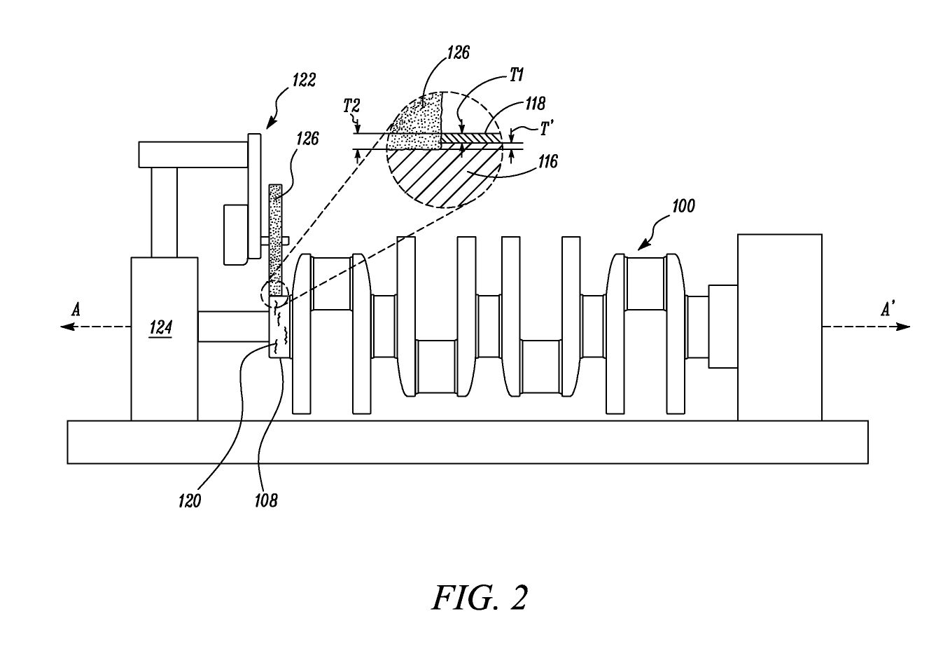

The component 100 of the engine is made of a substrate material 116 (shown in FIG. 2) and a heat treated hardened layer 118 (shown in FIG. 2) provided over the substrate material 116. The heat treated hardened layer 118 will be referred as “the heat treated layer 118” hereinafter. The heat treated layer 118 may have hardness greater than the hardness of the substrate material 116. The substrate material 116 may include a metal for example, heat treated steel or cast iron. Further, the heat treated layer 118 provided on the substrate material 116 has a thickness T1 (clearly shown in FIG. 2). In one embodiment, the thickness T1 may range between 0.5 to 2 mm. For exemplary purposes, the bearing surface 108 includes defects shown as wear marks 120 on the heat treated layer 118. The wear marks 120 may be formed on the heat treated layer 118 during normal operation of the engine.

The present disclosure contemplates removing a layer of thickness T2 from the bearing surface 108 having the wear marks 120. FIG. 2 illustrates a set-up wherein the layer with thickness T2 is removed from the bearing surface 108, according to an embodiment of the present disclosure. In the illustrated embodiment, the thickness T2 of the removed layer is greater than the thickness T1 of the heat treated layer 118, such that the thickness T2 may also include a thickness T′ of the substrate material 116. The thickness T′ of the substrate material 116 being removed from the bearing surface 108 may lie in a range between 10-20% of the thickness T1 of the heat treated layer 118. However, in a situation wherein the defects also includes a part of the substrate material 116, the thickness T′ being removed may be greater than 10-20% of the thickness T1 of the heat treated layer 118. In one example, the thickness T′ of the substrate material 116 being removed may be greater than the thickness T1 of the heat treated layer 118. Alternatively, the thickness T2 being removed from the bearing surface 108 may correspond to the thickness T1 of the heat treated layer 118, such that a surface of the substrate material 116 is exposed. In this example, T′ is substantially equal to zero.

Referring to FIG. 2, a grinder 122 is used for machining the layer of thickness T2 from the bearing surface 108. The component 100 is mounted upon a fixture 124 at or in a machine system including the grinder 122. A grinding wheel 126 of the grinder 122 is positioned in contact with the bearing surface 108. One or both of the grinding wheel 126 and the component 100 may be rotated for machining of the bearing surface 108. Further, the bearing surface 108 is machined to remove a cylindrical volume having the thickness T2. It should be noted that the set-up shown in FIG. 2 is exemplary in nature and the thickness T2 may be removed using any other machining processes known in the art, such as turning, milling, and the like. Accordingly, a conventional or a CNC lathe machine, a milling machine, and the like may be used. Alternatively, the machining may be done using processes, such as electrical discharge machining, electrochemical machining, electron beam machining, photochemical machining, and ultrasonic machining.

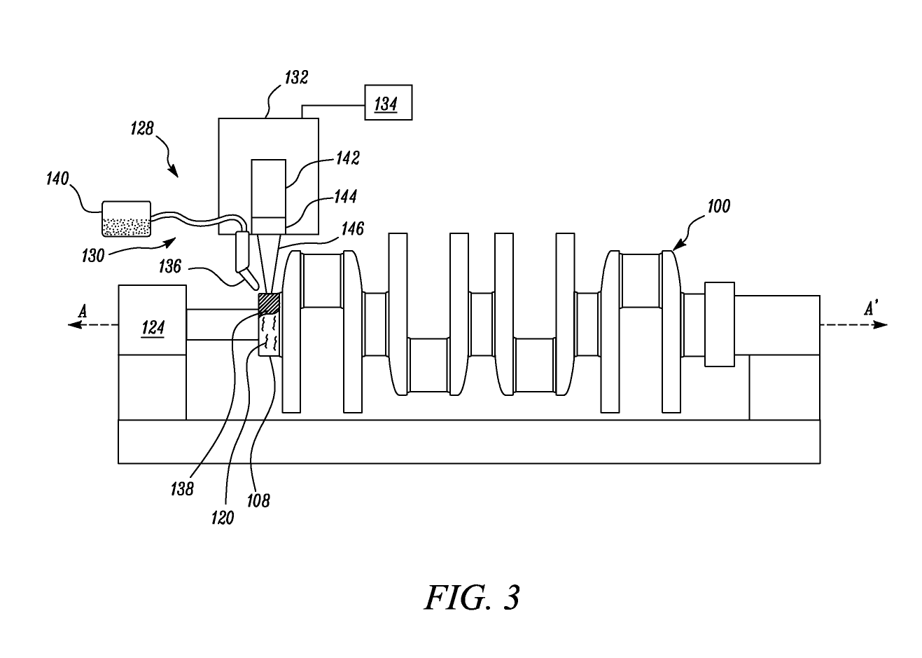

Referring to FIG. 3, the component 100 is shown positioned within the fixture 124 and held therein for further processing. A laser cladding system 128 is provided in association with the component 100. The laser cladding system 128 includes a laser head 132 and a laser control system 134. The laser cladding system 128 may also include a power supply to power the laser cladding system 128.

The laser cladding system 128 also includes a feedstock material supply mechanism 130. The feedstock material supply mechanism 130 of the laser cladding system 128 includes a nozzle 136. The nozzle 136 is configured to discharge a feedstock material such as a cladding material 138. The cladding material 138 is supplied from a reservoir 140 for fusing a cladding coating on the bearing surface 108. In one embodiment, multiple conduits may be provided between the reservoir 140 and the nozzle 136. In the illustrated embodiment, the feedstock material supply mechanism 130 may provide the cladding material 138 in the form of a powder. Alternatively, the feedstock material supply mechanism 130 may supply the cladding material 138 in the form of an elongate member (not shown), such as a wire or a strip, for instance. It should be noted that the feedstock material supply mechanism 130 explained herein is exemplary. Accordingly, the cladding material 138 may be provided on the substrate material 116 using any system and method known in the art. For example, a paste-like cladding material 138 may be pre-placed on the bearing surface 108.

In one embodiment, the cladding material 138 is similar to the substrate material 116. In an alternate embodiment, the cladding material 138 may be different from the substrate material 116. In such cases, the cladding material 138 may have desirable properties, such as wear resistance, fatigue strength, and the like. Further, the cladding material 138 is selected such that, the cladding material 138 may metallurgically bond with the substrate material 116. In one example, the cladding material 138 used may be an iron-based steel alloy and/or nickel based alloys. A suitable steel cladding material for cladding a forged, carbon steel machine component may be a mixture or uniform composition of hard facing tool steel materials and potentially others, although the present disclosure is not thereby limited.

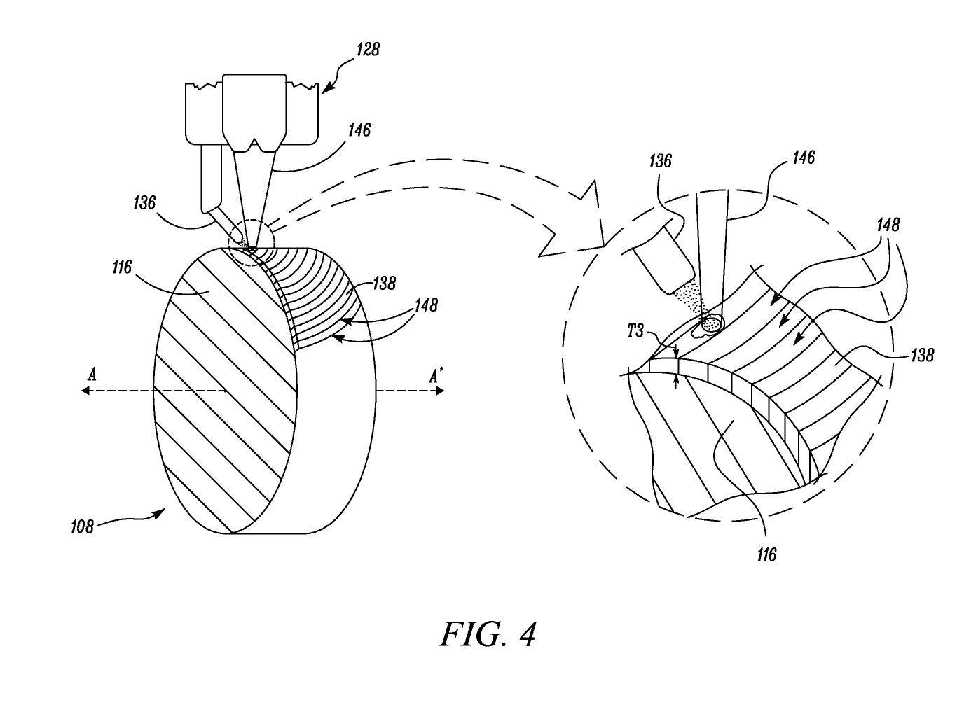

In the illustrated embodiment, the laser head 132 is configured to perform a bead scan on the bearing surface 108 of the component 100. The term “bead scan” used herein refers to a formation of a molten bead of the cladding material 138 on the bearing surface 108. FIG. 4 is a perspective view of the bearing surface 108 of the component 100. As shown in the accompanying figure, the bearing surface 108 may be divided into a number of portions on which the bead scan is to be performed. In the illustrated embodiment, a single bead scan is performed on each of the portions. A relative movement may be provided between the laser head 132 and the component 100 after each bead scan, such that the overall surface of the bearing surface 108 is uniformly laser clad.

Further, the laser head 132 includes a laser source 142 and optics 144. The laser source 142 produces a laser beam 146. In one embodiment, the optics 144 may be fixed. Further, the laser head 132 may be movable by any mechanical means known in the art. The laser beam 146 is configured to melt the cladding material 138 deposited on the bearing surface 108. The laser beam 146 used may be coherent light or more generally electromagnetic radiation. In the illustrated embodiment, the laser head 132 may direct a single laser beam 146 on to the surface of the bearing surface 108.

The optics 144 of the laser head 132 may receive and direct the laser beam 146 along a bead scanning length. The bead scanning length may be defined as a length along which the bead scan is expected to be performed. The laser control system 134 of the laser cladding system 128 may be configured to control or instruct the laser head 132 to direct the laser beam 146 across the bead scan length during the bead scan. Each time the laser beam 146 is directed across the bead scan length may be considered as a pass. In the illustrated embodiment, the bead scan includes a single pass. More specifically, in order to melt the cladding material 138 during the bead scan, the laser beam 146 is directed only once across the bead scan length. In one embodiment, the beading module may also be configured to control a supply of the cladding material 138 during each bead scan. Accordingly, the supply of the cladding material 138 coincides with the movement of the laser beam 146 during the bead scan. As illustrated in the accompanying figure, the nozzle 136 is provided at an angle to the laser beam 146. Alternatively, the nozzle 136 and the laser head 132 may be co-axially mounted. It should be noted that the details of the control of the laser beam 146 as disclosed herein is exemplary and alternate control strategies are possible within the scope of the present disclosure.

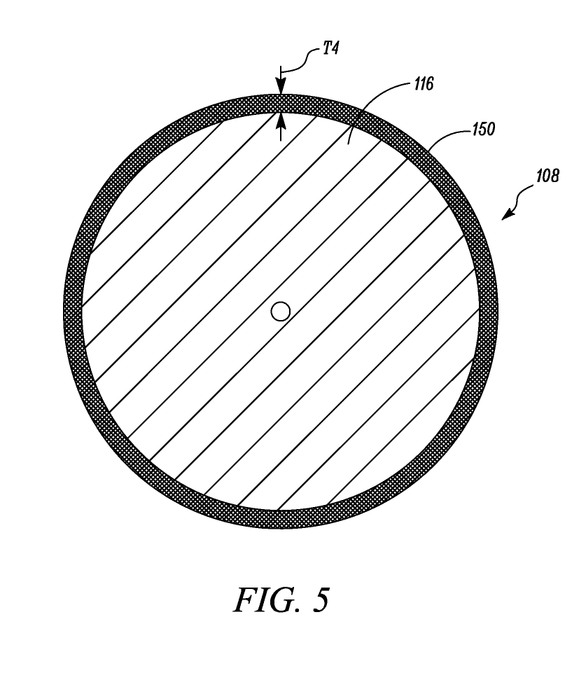

The laser beam 146 is configured to melt the cladding material 138 in order to form the molten bead of the cladding material 138 over the bead scan length. In an embodiment, the component 100 may be moved relative to the laser beam 146 along the bead scanning length, to melt the cladding material 138. In other example, the laser beam 146 may be moved relative to the component 100. As shown in the accompanying figures, a travel path of the laser beam 146 may be curvilinear. In alternate embodiments, the travel path of the laser beam 146 may be parallel or perpendicular to the axis A-A′ or may include a continuous spiral path. Further, on solidification, the molten cladding material 138 metallurgically bonds to the substrate material 116 of the bearing surface 108 forming a bead 148 (see FIG. 5). The bead 148 so formed may have a thickness T3.

As disclosed above, after the formation of the single layered bead 148, the component 100 and/or the laser beam 146 may be moved for formation of a subsequent bead 148. The subsequent bead 148 may be adjacent to the previously formed bead 148. It should be noted that the beads 148 so formed may be parallel to each other. Alternatively, the beads 148 may include a continuous spiral configuration. The configuration of the beads 148 may depend on the travel path of the laser beam 146. Further, the plurality of beads 148 forms a single layered coating 150 (See FIG. 5) on the component 100. The single layered coating 150 may have hardness greater than the hardness of the removed heat treated layer 150. Further, in the situation wherein the thickness T′ of the substrate material 116 being removed is approximately 1 mm or more, a replacement layer of the substrate material 116 is provided on the component 100. In this example, the single layered coating 150 is formed over the provided replacement layer. The replacement layer may be provided using any method known in the art.

FIG. 5 is a perspective view of the remanufactured bearing surface 108 with the single layered coating 150. It should be noted that the single layered coating 150 may have the thickness T3 equal to or greater than the thickness T1 of the machined heat treated layer 118. In an example wherein the machined thickness T2 corresponds to a combined thickness T1 of the removed heat treated layer 118 and the thickness T′ of the removed substrate material 116, the thickness T3 of the single layered coating 150 is greater than or equal to the combined thickness of the removed heat treated layer 118 and the removed substrate material 116. Further, the component 100 may undergo further processing in order to achieve a desired level of surface finish and also to achieve a desired dimension of the component 100. Hence, the single layered coating 150 may be machined to obtain a desired thickness T4. It should be noted that the single layered coating 150 having the thickness T3 may be machined in a manner similar to that explained with respect to FIG. 2, in order to obtain the single layered coating 150 of the thickness T4.

It should be noted that the application of the present disclosure is not limited to the remanufacturing of the bearing surface 108 of the component 100. The present invention can also be applied to the remanufacturing of other high performance parts, such as for example, transmission shafts, differentials, camshafts, plungers, bearings, engine valves, etc.

### INDUSTRIAL APPLICABILITY

The heat treated layer provided on the surface of the engine components require remanufacturing due to the presence of defects thereon. In known solutions, multiple layers of metal are deposited on the surface of the components using laser cladding techniques. However these solutions may not provide the same material quality as the heat treatment processes.

The present disclosure relates to a method wherein the single layered coating 150 of the cladding material 138 is provided on the bearing surface 108 of the component 100 to replace the original heat treated layer 118. The current approach of providing the single layered coating 150 helps in achieving a required material performance and may also increase a service life of the remanufactured components.

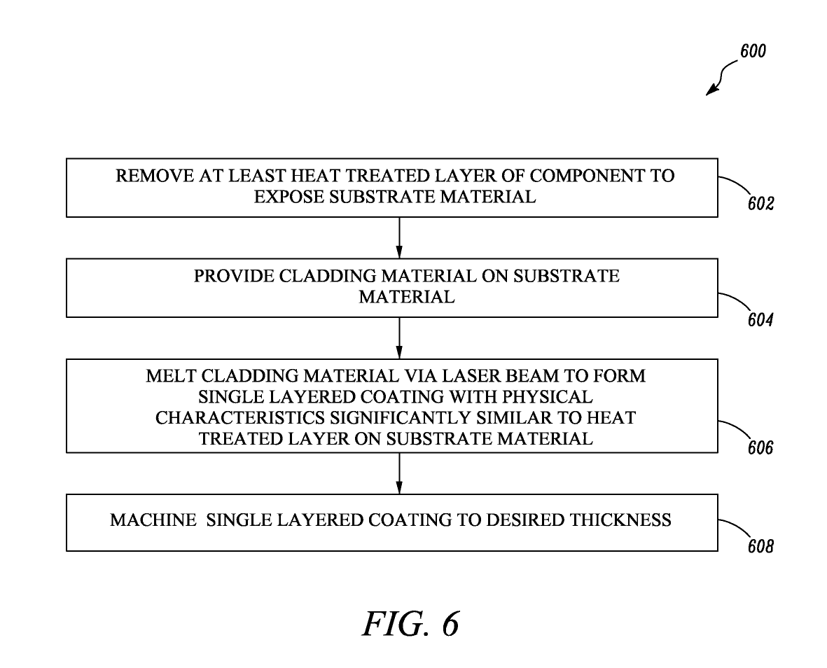

FIG. 6 is a method 600 of remanufacturing the component 100 (the crankshaft) having the heat treated layer 118 over the substrate material 116. At step 602, the method 600 includes removing the layer of thickness T2 from the surface of the bearing surface 108. In one embodiment, the thickness T2 of the layer being removed may include the combined thickness T1 of the heat treated layer 118 and the thickness T′ of the substrate material 116. Alternatively, the thickness T2 of the layer being removed may be equal to the thickness T1 of the heat treated layer 118, such that the surface of the substrate material 116 is exposed. The heat treated layer 118 of the bearing surface 108 may be removed by machining. In one embodiment, the grinder 122 may be used to machine the bearing surface 108 up to the thickness T2.

At step 604, the method 600 includes providing the cladding material 138 on the substrate material 116. The nozzle 136 of the material supply mechanism 130 may be used to fuse the cladding material 138 on the substrate material 116. The nozzle 136 receives the cladding material 138 from the feedstock material supply mechanism 130 in the form of the elongate member, such as for example, the wire or a strip. Further, the cladding material 138 is different from the substrate material 116 of the bearing surface 108.

At step 606, the method 600 includes melting of the cladding material 138 provided on the surface of the bearing surface 108, using the laser beam 146 to form the single layered coating 150. The single layered coating 150 includes the plurality of beads 148. The laser beam 146 is directed over the bead scan length of the portion 142 only once, in order to melt the cladding material 138 forming the bead 148. In a subsequent step, the component 100 may be moved to bead scan the adjacent portion of the bearing surface 108. Further, on solidifying, the melted cladding material 138 metallurgically bonds to the substrate material 116 of the bearing surface 108 forming the bead 148. It should be noted that the thickness T3 of the single layered coating 150 so formed may be greater or equal to the thickness T1 of the heat treated layer 118. At step 608, the single layered coating 150 of thickness T3 is machined in order to obtain the single layered coating 150 having the desired thickness T4. The present method 600 therefore allows for a control of the dimensions of the remanufactured component 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of remanufacturing a component having a heat treated hardened layer over a substrate material, the method comprising:
removing at least the heat treated hardened layer of the component to expose the substrate material;
providing a cladding material on the substrate material;
melting the cladding material via a laser beam to form a single layered coating with hardness greater than or substantially equal to hardness of the heat treated hardened layer on the substrate material; and
machining the single layered coating to a desired thickness.

2. A method of claim 1, wherein the single layered coating has a thickness greater than a thickness of the removed heat treated hardened layer.

3. A method of claim 1, wherein melting the cladding material includes directing the laser beam only once over a portion of the component.

4. A method of claim 1, wherein melting the cladding material includes melting the cladding material such that the melted cladding material upon solidifying metallurgically bonds to the substrate material of the component.

5. A method of claim 1, wherein removing the heat treated hardened layer of the component includes machining the component to a thickness of the heat treated hardened layer.

6. A method of claim 1, wherein removing the heat treated hardened layer of the component includes machining a thickness greater than the thickness of the heat treated hardened layer.

7. The method of claim 1, wherein providing the cladding material on the substrate material includes applying the cladding material via a nozzle on the substrate material.

8. The method of claim 1, wherein the single layered coating includes a plurality of beads.

9. The method of claim 1, wherein the cladding material is different from the substrate material.

10. A method of remanufacturing a component having a heat treated hardened layer over a substrate material, the method comprising:
removing the heat treated hardened layer and a thickness of the substrate material exposing a surface underneath;
providing a cladding material on the surface;
melting the cladding material via a laser beam to form a single layered coating with hardness greater than or substantially equal to hardness of the heat treated hardened layer on the surface, wherein the single layered coating has a thickness greater than a thickness of the heat treated hardened layer; and
machining the single layered coating to a desired thickness.

11. A method of claim 10, wherein melting the cladding material includes directing the laser beam only once over a portion of the component.

12. A method of claim 10, wherein melting the cladding material includes melting the cladding material such that the melted cladding material upon solidifying metallurgically bonds to the substrate material of the component.

13. The method of claim 10, wherein providing the cladding material on the surface includes applying the cladding material via a nozzle on the substrate material.

14. The method of claim 10, wherein the single layered coating includes a plurality of beads.

15. The method of claim 10, wherein the cladding material is different from the substrate material.

16. A remanufactured component having a substrate material, the remanufactured component prepared by a process comprising the steps of:
removing at least a heat treated hardened layer of an original component to expose the substrate material;
providing a cladding material on the substrate material;
melting the cladding material via a laser beam in a single pass to form a single layered coating with hardness greater than or substantially equal to hardness of the heat treated hardened layer on the substrate material, wherein the single layered coating has a thickness greater than a thickness of the removed heat treated hardened layer; and
machining the single layered coating to a desired thickness in order to provide the remanufactured component.

17. The method of claim 16, wherein the cladding material is different from the substrate material.

18. The remanufactured component of claim 16, wherein the step of melting the cladding material includes directing the laser beam only once over a portion of the component.

19. The remanufactured component of claim 16, wherein the step of removing the heat treated hardened layer of the component includes machining the component to a thickness of the heat treated hardened layer.

20. The remanufactured component of claim 16, wherein the step of removing the heat treated hardened layer of the component includes machining the component to a thickness greater than the thickness of the heat treated hardened layer.
